(19) United States
(12) Patent Application Publication
(10) Pub. No.: US 2026/0218786 A1
(43) Pub. Date: Jul. 30, 2026

(54) STACKED SPROCKET AND PULLEY

(71) Applicant: Gates Corporation, Denver, CO (US)

(72) Inventors: Bret Cash, Denver, CO (US); Wesley Alvis, Denver, CO (US)

(73) Assignee: Gates Corporation, Denver, CO (US)

(21) Appl. No.: 19/141,256

(22) PCT Filed: Dec. 18, 2023
(86) PCT No.: PCT/US2023/084518

§ 371 Date: Jun. 19, 2025

Related U.S. Application Data
(60) Provisional application No. 63/434,019, filed on Dec. 20, 2022.

(51) Int. Cl. F16H 55/12; F16H 55/17; F16H 55/42

(52) U.S. Cl. CPC F16H 55/12; F16H 55/171; F16H 55/42

(57) ABSTRACT

To obtain maximum performance and decrease the overall production and design cost application-specific stacked sprockets and stacked pulleys may be utilized. A stacked sprocket may be manufactured utilizing low-cost manufacturing methods and low-cost sheet or plate material over a solid billet. The modularity of a stacked sprocket allows for easy design changes during the production of the stacked sprocket or pulley. The construction of the stacked sprocket and pulley is individually cut plates stacked together and sandwiched by a rivet, bolt, or the like. The plates are stacked and sandwiched together to form a complete sprocket or pulley.

### CROSS-REFERENCE TO RELATED APPLICATIONS

This application claims priority to U.S. Provisional Patent Application Ser. No. 63/434,019 filed Dec. 20, 2022, which is incorporated herein in its entirety by reference.

### TECHNICAL FIELD

The present invention relates to a stacked sprocket and pulley for mobility and industrial applications.

### BACKGROUND

The present disclosure is directed to a stacked sprocket and pulley such as for use with bicycles, motorcycles, industrial applications, and other systems that utilize a toothed belt, v-belt, or chain driven system as in the conventional personal transportation and industrial drive industries. Industries that use a belt or chain often require the use of a corresponding sprocket or pulley for desired performance and operation from the belt application. Modern pulleys and sprockets are costly and timely to produce either being manufactured from a solid piece of material or formed by casting or injection molding requiring costly tooling. Conventionally designed sprockets are difficult to modify or update during the prototyping stage of design and producing and designing multiple configurations can be costly. Similarly, each singular v-belt pully requires an application-specific belt and pulley width and application-specific pulley diameters to perform optimally. To produce application-specific pulleys requires custom, tooling such as die-cast molds or injection mold tooling. For machined pulleys and sprockets, machining parts from solid billet is expensive due to the amount of material waste from the machining process. Other traditional manufacturing methods such as die casting pulleys and sprockets are also prohibitively expensive due to the tooling cost and difficulty of changing a design once the tool is produced. This is especially true for low volume quantities. In a market where customers may demand application-specific sprockets or pulleys manufacturing for low volumes and modularity is critical.

The stacked sprocket and pulley of this disclosure are particularly suited for optimizing manufacturing efficiency, improving design lead time, and reducing overall system cost. The stacked sprocket and pulley may include a pulley and sprocket manufactured from individual plates or sheets stacked together to form the full tooth width or v-pulley profile.

### SUMMARY

In one embodiment a stacked sprocket may be utilized. A stacked sprocket may include but is not limited multiple components that when stacked and compressed together form a singular sprocket. In another embodiment a stacked pulley may be utilized. Similarly, a stacked pulley may include but is not limited multiple components that when stacked and compressed together form a singular pulley.

In one embodiment of a stacked sprocket and pulley a stacked sprocket may be configured in a driven or driver configurations. The driver sprocket being one that the power is generated at and the driven sprocket being the one that has power transferred to it through a toothed belt or chain from the driver sprocket. In another embodiment, a pulley, a poly-v pulley as a non-limiting example, may be configured as a driven pulley or a driver pulley. The driver pulley being the pulley that has power generated at it and the driven pulley being one that has power transferred to it through a v-belt or other belt configuration from the driver pulley. Stacked sprockets and pulleys may need to be mounted to either the inboard or outboard side of a drive system depending on the requirements. An inboard mounting would have the carrier or interface plate mounting the sprocket or pulley closest to the driver or driven component. A sprocket or pulley mounted on the outboard side would have the interface or carrier furthest away from the driver or driven component. Depending on the application the carrier or interface offset may be set to any necessary dimension or orientation.

Some benefits of the present invention may be that from a small stock of premade layers, maximum flexibility in design, manufacturing, and customer support may be obtained at minimal cost and effort. This may also facilitate more thorough testing and an increase in the optimization of application-specific solutions. In some embodiments, the stacked pulley and sprocket layers may be formed from metal, polymer, or composite material by machining, grinding, additive manufacturing, water jet or laser cutting, stamping, and the like. A manufacturing process may be performed individually or in combination with another to achieve the desired result. Differing materials may be utilized for the different components of the stacked pulley or sprocket. Hardening processes may be performed on select components of the stacked pulley or sprocket or may be performed on the assembly as a whole.

Additionally, or alternately, in other embodiments, components may be manufactured at various manufacturing sites and then shipped separately to the final installation location and assembled on-site for large industrial applications. Other embodiments are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

For specific sprockets and pulleys, refer to the sprockets and pulleys structures disclosed by and herein incorporated by reference, US20160138698A1.

### BRIEF DESCRIPTION OF THE DRAWINGS

FIG. 1 is an exemplary illustration of a stacked sprocket.

FIG. 2 is a detailed view of an exemplary embodiment of a stacked sprocket.

FIG. 3A shows an exemplary embodiment of a mudport section.

FIG. 3B shows an embodiment of a window section.

FIG. 3C shows an exemplary embodiment of a flange.

FIG. 3D shows an exemplary embodiment of a carrier section

FIG. 4 shows an example embodiment of a stacked pulley.

FIG. 5 shows an exemplary embodiment of a section of a stacked pulley showing tooth tip and tooth root detail.

FIG. 6 is an exploded view of an exemplary embodiment of a stacked pulley.

FIG. 7 is an exemplary embodiment of a stacked pulley viewed from the inboard side of the pulley.

FIG. 8 is an exemplary embodiment of a stacked pulley showing detail of the micro-v tooth profile.

### DETAILED DESCRIPTION

As described above, described herein are sprockets and pulleys utilizing a stacked assembly and manufacturing method to assist in rapid, low-cost, modular construction.

In the following description, reference is made to the accompanying drawings that forms a part hereof and in which is shown by way of illustration at least one specific embodiment. The following description provides additional specific embodiments. It is to be understood that other embodiments are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

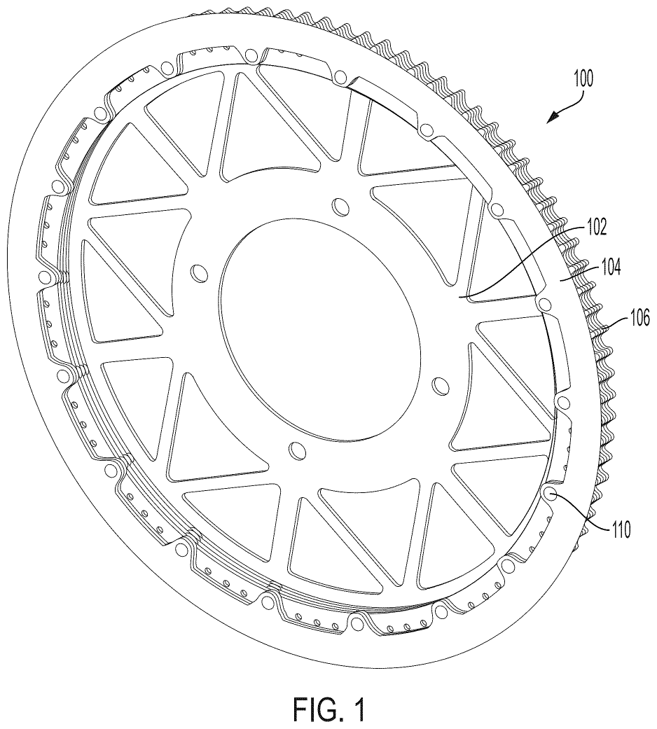

FIG. 1 is an exemplary illustration of a stacked sprocket. FIG. 1 shows a stacked sprocket 100 according to this disclosure. In some embodiments, the stacked sprocket 100 may include but is not limited to at least one carrier section 102, at least one flange 104, at least one window section 106, at least one mudport section 108, a clamping component 110, and the like. In some embodiments, carrier section 102, a flange 104, a window section 106, and a mudport section 108 may be made from stamped metal such as steel or aluminum alloys, engineering-grade polymers, fiber based composites, or the like. The carrier section 102, a flange 104, a window section 106, and a mudport section 108 may be manufactured individually or together by stamping, machining, casting, grinding, waterjet cutting, laser cutting, additive manufacturing, or by a combination of processes. In some embodiments, it may be beneficial to heat treat, coat, or hard anodize the carrier section 102, a flange 104, a window section 106, and a mudport section 108. In some embodiments the carrier section 102 may include a mudport feature to assist the mudport section 108 in shedding debris generated by the belt or from the surrounding environment. In some embodiments, it may be beneficial to include more than one carrier section 102 to increase the strength of the stacked sprocket assembly, as an example, two carrier sections 102 may be stacked consecutively for increased strength. Alternatively, two carrier sections 102 may be stacked apart from each other in the assembly to also increase strength by increasing the assembly moment of inertia. Depending on the offset requirement of the hub or crank assembly the carrier section 102 may be placed at the desired offset within the stack to accomplish the necessary offset. In some embodiments, the stacked sprocket 100 may be a driven sprocket or the driver sprocket, depending on what is required for the individual application.

In some embodiments, it may be beneficial to include a clamping component 110 to join the components of the stacked sprocket together. The clamping component 110 may include a plurality of clamping components 110 positioned around the stacked sprocket. The clamping component 110 may be a bolt and nut combination, rivet, press-fit pin, weld, or the like. The clamping component may be removable or in some embodiments may be permanent. The clamping component 110 may sandwich at least one carrier section 102, at least one flange 104, at least one window section 106, and at least one mudport section 108 together to form a complete stacked sprocket 100 assembly. In some embodiments, it may also be beneficial to include an adhesive or damping material between the carrier section 102, at least one flange 104, at least one window section 106, and at least one mudport section 108. This may facilitate additional bonding beyond the clamping force of the clamping component 110 or may also provide a damping mechanism for squeak and rattle purposes.

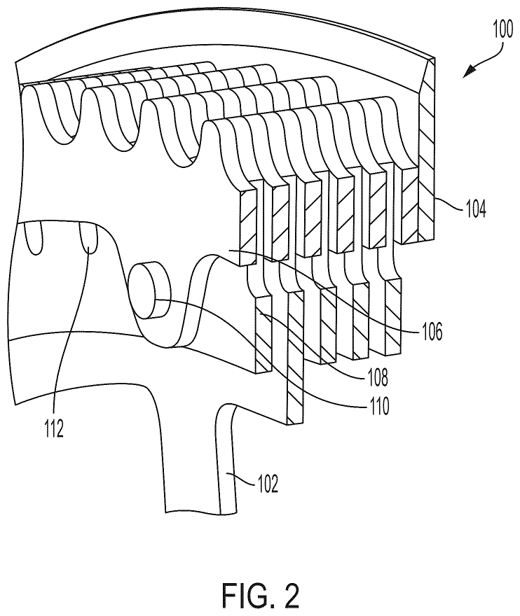

FIG. 2 is a detailed view of an exemplary embodiment of a stacked sprocket. FIG. 2 shows a stacked sprocket 100 according to this disclosure. In some embodiments the stacked sprocket 100 may include but is not limited to at least one carrier section 102, at least one flange 104, at least one window section 106, at least one mudport section 108, at least one clamping component 110, and the like. Different arrangements of window sections 106, carrier sections 102, and mudport sections 108 may be utilized depending on the embodiment. The stack may include alternating mudport sections 108 and window sections 106. In another embodiment, as a non-limiting example the stack may include an alternate stack of two mudport sections 108 stacked with one window section 104. In further alternate embodiments, the stack may be all window sections 106 if no debris shedding is required in the design. The window section 106 may be designed to allow clear access to the mudport reliefs 112. A window 114 may be present on the inner diameter of the window section 106 reviling the mudport reliefs 112. The window 114 may be a cutaway of material, a machined or cut slot, or the like.

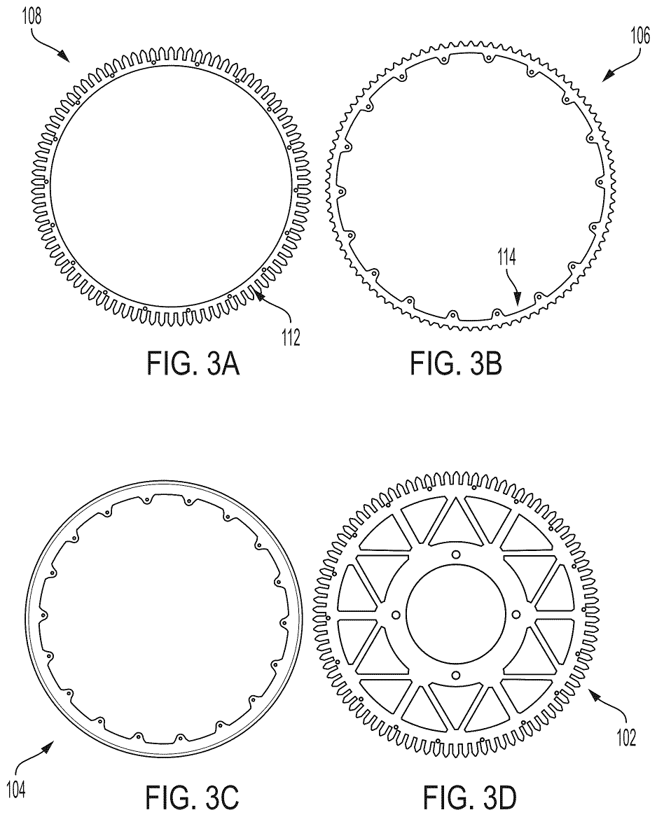

FIG. 3A shows an exemplary embodiment of a mudport section. In some embodiments, the mudport section 108 may be made from stamped metal such as steel or aluminum alloys, engineering-grade polymers, fiber based composites, or the like. The at least one mudport section 108 may be manufactured individually or together by stamping, machining, casting, grinding, waterjet cutting, laser cutting, additive manufacturing, or by a combination of processes. In some embodiments, it may be beneficial to heat treat, coat, or hard anodize the mudport section 108. Mudport reliefs 112 may be cut into the mudport section 108 to facilitate debris shedding. Mudport reliefs 112 may allow contaminants such as dirt, mud, worn belt material, grease, or the like to be removed from the tooth tip and root surfaces to allow for longer belt and sprocket life.

FIG. 3B shows an exemplary embodiment of a window section. The window 114 may be present on the inner diameter of the window section 106 reviling the mudport reliefs 112. The window 114 may be a cutaway of material, a machined or cut slot, or the like. In some embodiments, the window section 106 may be made from stamped metal such as steel or aluminum alloys, engineering-grade polymers, fiber based composites, or the like. The at least one window section 106 may be manufactured individually or together by stamping, machining, casting, grinding, waterjet cutting, laser cutting, additive manufacturing, or by a combination of processes. In some embodiments, it may be beneficial to heat treat, coat, or hard anodize the window section 106.

FIG. 3C shows an exemplary embodiment of a flange. In some embodiments at least one flange 104 may be used. The flange 104 may be sized according to the required tooth count of the sprocket. In some embodiments, the flange may include a lead-in chamfer to help avoid damage to the belt during installation or removal. The flange 104 may be positioned on the edge of the sprocket stack or in some embodiments could be a FinLine or Center track design. In some embodiments, the flange may lend itself to certain aesthetic options such as different colors, materials, finishes, and the like from the window section 106, mudport section 108, and carrier section 102. There may be many placement options for the flange 104 including, but not limited to, inboard, outboard, centerline, and utilizing a single flange 104 or double flange 104 to assist in securing and guiding the belt. In some embodiments, the at least one flange 104 may be made from stamped metal such as steel or aluminum alloys, engineering-grade polymers, fiber-based composites, or the like. The at least one flange 104 may be manufactured individually or together by stamping, machining, casting, grinding, waterjet cutting, laser cutting, additive manufacturing, or by a combination of processes. In some embodiments, it may be beneficial to heat treat, coat, or hard anodize the at least one flange 104.

FIG. 3D shows an exemplary embodiment of a carrier section. In some embodiments, the carrier section 102 may be designed to include a desired spoke design or hub pattern design. The carrier section 102 may be designed to attach the stacked sprocket 100 to the driven or driver component allowing the stacked sprocket to transmit power. In some embodiments, the carrier section 102 may include a bolted hub, splined hub, or the like to allow drive or driven power to transmit through the stacked sprocket 100. In some embodiments, the carrier section 102 may include at least two carrier sections 102, stacked together for increased strength. Two carrier sections stacked together for increased strength is a nonlimiting example; if the design requires multiple carrier sections 102 to be stacked together that is herein disclosed.

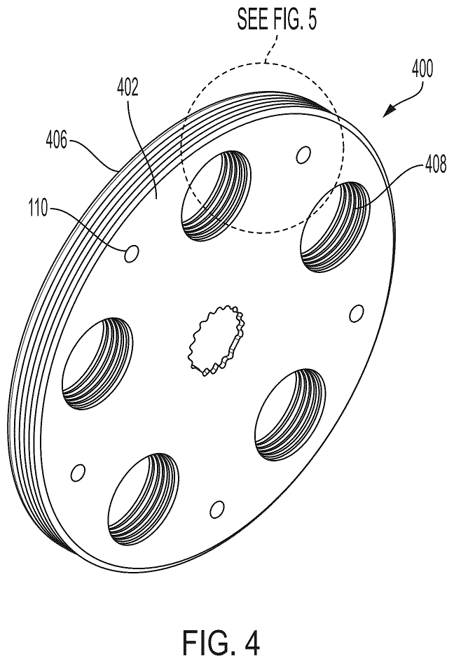

FIG. 4 shows an example embodiment of a stacked pulley. In some embodiments, a stacked pulley may include but is not limited to at least one interface plate 402, at least one tooth tip plate 406, at least one tooth root plate 408, and at least one clamping component 110. In some embodiments, there may be multiple tooth tip plates 406 and tooth root plates 408 in order to build a stacked pulley of the required width. In some embodiments, it may be beneficial to utilize an alternating pattern of at least one tooth tip plate 406 and at least one tooth root plate 408 to create the stacked pulley 400.

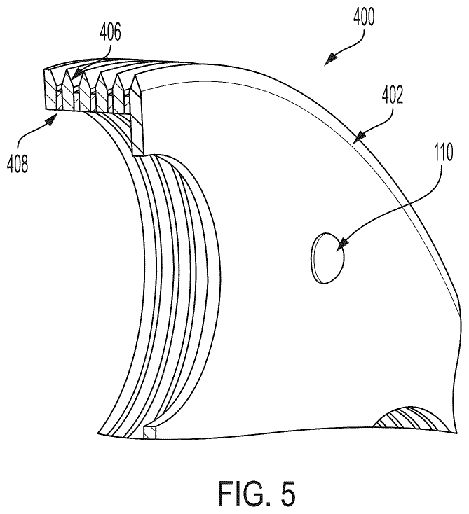

FIG. 5 shows an exemplary embodiment of a section of a stacked pulley showing tooth tip and tooth root detail. Section A-A is a zoomed-in image of the stacked sprocket shown in FIG. 4. In some embodiments the at least one tooth tip section 406 may be made from stamped metal such as steel or aluminum alloys, engineering-grade polymers, fiber-based composites, or the like. The at least one tooth tip section 406 may be manufactured individually or together by stamping, machining, casting, grinding, waterjet cutting, laser cutting, additive manufacturing, or by a combination of processes. In some embodiments, it may be beneficial to heat treat, coat, or hard anodize at least one tooth tip section 406. In some embodiments the at least one tooth tip section 406 may be manufactured from two distinct sections having the parting line be down the tip of the at least one tooth tip section 406. In this embodiment, the at least one tooth tip section 406 would have each side of the tooth tip section chamfered and the opposite angle chamfers or grinds would meet at the tip of the at least one tooth tip section 406. This may allow for easier grinding, cutting, or forming of the tooth tip chamfer. The tooth tip chamfer may be designed to match or accommodate the profile of a micro-v belt or any other ribbed or flat belt.

In some embodiments the at least one tooth root plate 408 may be made from stamped metal such as steel or aluminum alloys, engineering-grade polymers, fiber-based composites, or the like. The at least one tooth root plate 408 may be manufactured individually or together by stamping, machining, casting, grinding, waterjet cutting, laser cutting, additive manufacturing, or by a combination of processes. In some embodiments, it may be beneficial to heat treat, coat, or hard anodize at least one tooth root plate 408. In some embodiments, at least one tooth root plate 408 may include a debris-shedding feature that allows for contaminants to evacuate the pulley so damage to the belt does not occur. This may appear as a cut out in the tooth root plate similar to the window 114 of the window section 106 of a stacked sprocket 100 or it may be a missing section of the tooth root plate 408.

In some embodiments it may be beneficial to stack the plates utilizing an alternating tooth tip plate 406 and tooth root plate 408. This may ensure that the proper tooth profile is produced. The at least one tooth tip plate 406, at least one tooth root plate 408, and at least one interface plate 402 may then be joined together utilizing a clamping component 110 such as but not limited to a nut and bolt, rivet, adhesive, press fit pin, or the like. The clamping component 110 may also be a permanent fastener such as but not limited to an adhesive or weld. In some embodiments, it may also be beneficial to include an adhesive or damping material between the interface plate 402, at least one tooth tip plate 406, and at least one tooth root plate 408. This may facilitate additional bonding beyond the clamping force of the clamping component 110 or may also provide a damping mechanism for squeak and rattle purposes.

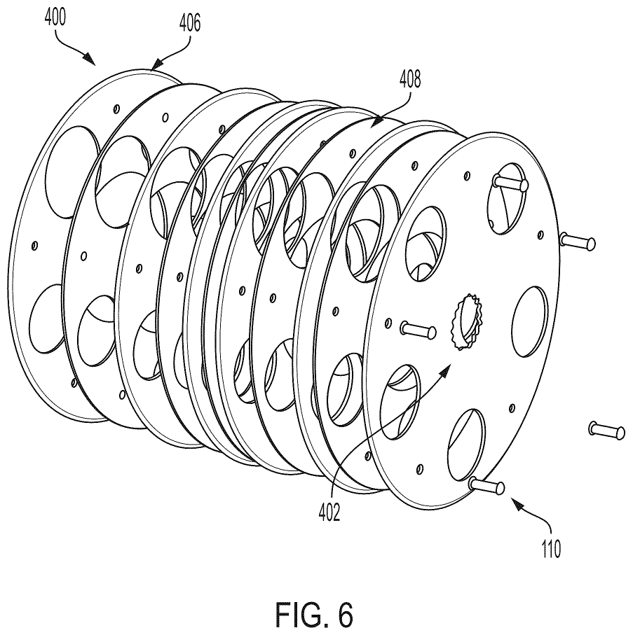

FIG. 6 is an exploded view of an exemplary embodiment of a stacked pulley. FIG. 6 shows a stacked pulley 400 according to this disclosure. In some embodiments, the stacked pulley 400 may include but is not limited to at least one interface plate 402, at least one tooth tip plate 406, at least one tooth root plate 408, and at least one clamping component 110. In some embodiments an at least one interface plate may be used to attach the stacked pulley 400 to a drive or driven shaft by utilizing splines, a keyway, bolted pattern, or the like. The interface plate 402 may be one or more stacked interface plates. In some embodiments, there may be an additional interface plate allowing the at least one tooth tip plate 406 and at least one tooth root plate 408 to be sandwiched between interface plates 402. This may allow a shaft to pass through the entire width of the stacked pulley 400 or to mount another component, such as but not limited to a fan clutch, fan, secondary pulley, or sensing device to a second interface plate. In embodiments where a single interface plate 402 is used the interface plate 402 may be placed anywhere in the stack of plates to obtain the desired pulley mounting offset.

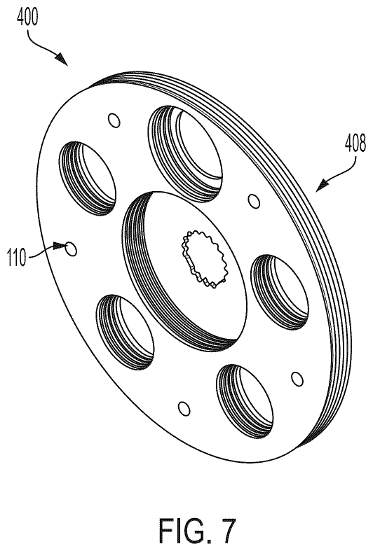

FIG. 7 is an exemplary embodiment of a stacked pulley viewed from the inboard side of the pulley. In some embodiments, the at least one tooth tip plate 406 may be made from may be made from metal sheet or plate such as steel or aluminum alloys, engineering-grade polymers, fiber based composites, or the like. In some embodiments the at least one tooth tip plate 406 may be manufactured individually or together by stamping, machining, casting, grinding, waterjet cutting, laser cutting, additive manufacturing, or by a combination of processes. In some embodiments, the at least one tooth root plate 408 may be made from metal sheet or plate such as steel or aluminum alloys, engineering-grade polymers, fiber based composites, or the like. In some embodiments the at least one tooth root plate 408 may be manufactured individually or together by stamping, machining, casting, grinding, waterjet cutting, laser cutting, additive manufacturing, or by a combination of processes. In some embodiments the at least one tooth tip plate 406 and the at least one tooth root plate 408 may have holes or pockets machined or cut out for weight reduction, aesthetics, or for interference with a spline or bolt holes.

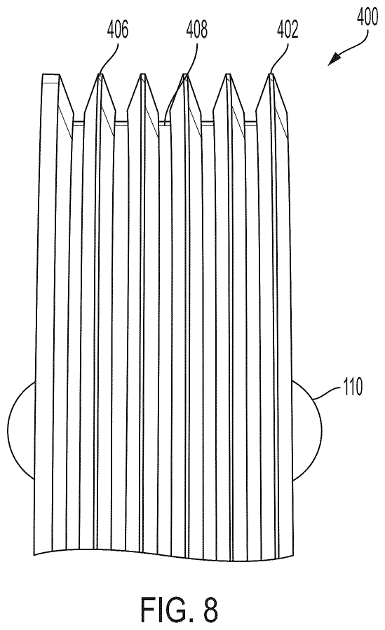

FIG. 8 is an exemplary embodiment of a stacked pulley showing detail of the micro-v tooth profile. In some embodiments the at least one tooth tip plate 406 poly-v profile may be formed by machining the tooth tip plate 406 on a lathe with a form tool. The poly-v profile may also be ground or formed utilizing two half tooth tip plates with opposite-angle chamfer sandwiched together to form one tooth tip plate 406.

In the aforementioned embodiments, with reference to FIG. 1 and FIG. 4, the interface plate or carrier section is provided on the inboard side of the stacked sprocket or stacked pulley. In other embodiments, the interface plate or carrier section may be provided on the inboard side of the stacked sprocket or stacked pulley, i.e. the inboard and outboard positions of the stacked sprocket and stacked pulley are switched with each other. Positioning of the individual components in a stacked sprocket and stacked pulley are not limiting and may be arranged based on the design requirements of each individual application.

The above specification and examples provide a complete description of the structure and use of exemplary embodiments of the invention. The above description provides specific embodiments. It is to be understood that other embodiments are contemplated and may be made without departing from the scope or spirit of the present disclosure. The above-detailed description, therefore, is not to be taken in a limiting sense. For example, elements or features of one example, embodiment or implementation may be applied to any other example, embodiment or implementation described herein to the extent such contents do not conflict. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a,” “an,” and “the” encompass implementations having plural referents, unless the content clearly dictates otherwise. As used in this specification and the appended claims, the term “or” is generally employed in its sense including “and/or” unless the content clearly dictates otherwise.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

What is claimed is:

1. A stacked sprocket comprising:
at least one carrier section;
at least one flange;
at least one window section; and
at least one clamping component, wherein the clamping component sandwiches the at least one carrier section, the at least one flange, and the at least one window section.

2. The stacked sprocket of claim 1, further comprising at least one mudport section.

3. The stacked sprocket of claim 2, wherein the at least one window section and the at least one mudport section are arranged in an alternating pattern.

4. The stacked sprocket of claim 1 wherein the at least one flange is arranged on the outboard side of the stacked sprocket.

5. The stacked sprocket of claim 1 wherein the at least one flange is arranged on the inboard side of the stacked sprocket.

6. The stacked sprocket of claim 1 wherein the at least one flange is arranged on the in the center of the stacked sprocket.

7. The stacked sprocket of claim 6 wherein the at least one flange is arraigned in the center of the stacked sprocket and includes a chamfer on both the inboard and outboard side of the flange.

8. The stacked sprocket of claim 1 wherein the at least one clamping component is a rivet.

9. The stacked sprocket of claim 1 wherein the at least one clamping component is a bolt and nut.

10. The stacked sprocket of claim 1 wherein the at least one window section is hardened.

11. A stacked pulley comprising:
at least one tooth tip section;
at least one tooth root plate;
at least one interface section; and
at least one clamping component, wherein the clamping component sandwiches the at least one tooth tip section, the at least one tooth root plate, and the at least one interface section.

12. The stacked pulley of claim 11 wherein the at least one tooth tip section and the at least one tooth root plate are arranged in an alternating pattern.

13. The stacked pulley of claim 11 wherein the at least one tooth root plate includes a debris-shedding window.

14. The stacked pulley of claim 11 wherein the at least one interface section is arranged on the outboard side of the stacked sprocket.

15. The stacked pulley of claim 11 wherein the at least one interface section is arranged on the inboard side of the stacked sprocket.

16. The stacked pulley of claim 11 wherein the at least one tooth tip plate is formed from two opposite chamfer angle tooth tip plates.

17. The stacked pulley of claim 11 wherein the interface section has a splined interface.

18. The stacked pulley of claim 11 wherein the interface section has a bolted hub pattern interface.

19. The stacked pulley of claim 11 further comprising a second interface section configured on the opposite end of the stacked pulley from a first interface section.

20. The stacked pulley of claim 11 wherein the at least one clamping component is a rivet.
